(19) United States
(12) Patent Application Publication
(10) Pub. No.: US 2025/0110242 A1
(43) Pub. Date: Apr. 3, 2025

(54) GNSS SATELLITE SIGNAL AUTHENTICATION

(71) Applicant: BAE Systems Information and Electronic Systems Integration Inc., Nashua, NH (US)

(72) Inventor: John J. Weger, Ely, IA (US)

(73) Assignee: BAE Systems Information and Electronic Systems Integration Inc., Nashua, NH (US)

(21) Appl. No.: 18/479,272

(22) Filed: Oct. 2, 2023

(51) Int. Cl. G01S 19/21; G01S 5/02; G01S 19/08

(52) U.S. Cl. CPC G01S 19/215; G01S 5/0252; G01S 19/08

(57) ABSTRACT

A global navigation satellite system (GNSS) signal authentication methodology includes receiving, by one or more processors, a first digital signal and a second digital signal, the first digital signal and the second digital signal each representative of a GNSS satellite signal received from a GNSS satellite and including a ranging code that uniquely identifies the GNSS satellite, the first and second GNSS satellite signals transmitted contemporaneously from physically separate antennas onboard the GNSS satellite. The methodology continues with computing, by the one or more processors, a digital fingerprint based on the first digital signal and the second digital signal, and determining, by the one or more processors, that the first GNSS satellite signal and the second GNSS satellite signal are authentic (or not) based on the digital fingerprint. If the first and/or second GNSS satellite signals are found to not be authentic, remedial action may be taken.

### FIELD OF DISCLOSURE

The present disclosure relates to the global navigation satellite system (GNSS), and more particularly, to techniques for authenticating GNSS satellite signals based on a digital fingerprint.

### BACKGROUND

GNSS is a geopositioning system that uses signals transmitted by a constellation of satellites in Earth orbit to determine the location of a receiver. The Global Positioning System (GPS) is one type of GNSS. Although GNSS allows the receivers to determine location with high precision, it is possible to compromise the accuracy of the information by transmitting, to a receiver, false or corrupted signals designed to emulate true satellite signals. Such activity is commonly referred to as spoofing. Spoofing may be used, for example, to deceive GNSS/GPS devices into displaying inaccurate positioning and timing information, such as during a defensive electromagnetic attack or other threat situation. Therefore, there is a need for techniques to detect spoofed GNSS satellite signals for maintaining the integrity of the information provided to the GNSS user.

### BRIEF DESCRIPTION OF THE DRAWINGS

FIG. 1 is a block diagram of a GNSS satellite system, in accordance with an example of the present disclosure.

FIG. 2 depicts a representative constellation of GPS satellites in medium Earth orbit, in accordance with an example of the present disclosure.

FIG. 3 depicts a view of the sky from the perspective of a receiver of the GNSS satellite system of FIG. 1, in accordance with an example of the present disclosure.

FIG. 4 is a block diagram of the GNSS satellite system of FIG. 1 showing a satellite platform at different orbital locations with respect to a receive antenna, in accordance with an example of the present disclosure.

FIG. 5 is a block diagram of the receiver of the GNSS satellite system of FIG. 1, in accordance with an example of the present disclosure.

FIG. 6 is a block diagram of a portion of the receiver of the GNSS satellite system of FIG. 1, in accordance with an example of the present disclosure.

Although the following detailed description will proceed with reference being made to illustrative embodiments, many alternatives, modifications, and variations thereof will be apparent in light of this disclosure.

### DETAILED DESCRIPTION

A GNSS signal authentication system is described. In an example, the system includes a receive antenna and a processor, and may further include a circuit (e.g., a radio frequency receiver circuit) configured to generate a first digital signal and a second digital signal representative of a first GNSS satellite signal and a second GNSS satellite signal, respectively, from a single satellite received via the receive antenna. The first digital signal and the second digital signal are provided to the processor, and each include a ranging code that uniquely identifies a GNSS satellite contemporaneously transmitting the first GNSS satellite signal and the second GNSS satellite signal from physically separate antennas onboard the GNSS satellite. The processor is configured to compute a digital fingerprint based on the first digital signal and the second digital signal, and determine that the first GNSS satellite signal and the second GNSS satellite signal are authentic (or suspect) based on the digital fingerprint. In some examples, the digital fingerprint is a function of a measured relationship between the first digital signal and the second digital signal. The first digital signal and the second digital signal are representative of the first GNSS satellite signal and the second GNSS satellite signal, respectively. The digital fingerprint is determined to be authentic if the measured relationship is the same as, or otherwise within an acceptable tolerance of, an expected relationship between the first digital signal and the second digital signal for an orbital location of the GNSS satellite with respect to a location of the receive antenna. The expected (or predicted) relationship between the first digital signal and the second digital signal is based on satellite ephemeris and the location of the receive antenna relative to the orbital location of the GNSS satellite. The measured relationship and the expected relationship each represent a range difference between the first digital signal and the second digital signal, where the range difference is scaled by a cosine of an arc angle between the location of the receive antenna and a point nadir of the GNSS satellite with respect to the location of the receive antenna. The function of the measured relationship between the first digital signal and the second digital signal includes a differential code bias that is unique to the GNSS satellite. In some examples, the first GNSS satellite signal is an Earth coverage M-code signal, and the second GNSS satellite signal is an RMP (Regional Military Protection) signal. Numerous other embodiments and variations will be apparent.

### Overview

Spoofed or falsified GNSS and GPS signals can imitate authentic signals so as to mislead a user into believing that the information is accurate when it is not. For example, a signal spoofer may seek to interfere with the authentic signal broadcast from a GNSS/GPS satellite by broadcasting another signal that appears to originate from a satellite in the GNSS/GPS constellation. Thus, there is a need to reliably determine whether an apparent GNSS/GPS signal is genuine before using the information derived from the signal for navigation or other purposes, and/or to warn the user that the information is not from a verified source.

In accordance with an example of the present disclosure, a technique for GNSS signal authentication leverages the ability of a GNSS satellite to contemporaneously provide two or more signals from physically separate antennas. For example, each GPS satellite broadcasts several ranging codes and navigation data, such as an Earth Coverage signal including C/A-code (Coarse Acquisition Code), P(Y)-code (encrypted precision code), and M-code (military code), as well as RMP ranging waveforms. While C/A and P(Y) are generated from a single antenna, Earth coverage M-code and RMP are broadcast from two or more physically separate (geometrically displaced) antennas on the satellite vehicle. In accordance with an embodiment of the present disclosure, the signals transmitted contemporaneously from each of the antennas on the same satellite can be used by a receiver in several ways to authenticate the signals.

For example, the receiver can authenticate the signal based on the geometry of different antennas that are not co-located on the satellite platform. In other words, where the antennas are displaced from each other, the signals arrive at the receiver from different angles and at different times, causing a geometric ranging bias. Physical separation of the antennas on the satellites creates a so-called lever arm, which is a geometric construct representing the differences in signal origin with respect to the receiver. From the perspective of the receiver, the lever arm is constantly changing as a function of satellite motion as the satellite progresses in its orbit and as it rotates to maintain its orientation with Earth. Knowledge of the lever arm geometry for a given satellite in conjunction with a known (expected) differential code bias for the signals transmitted from the satellite can be used to create an extremely precise, unique, and ever-changing signature as a function of the geometric ranging bias between the two signals. In this manner, a receiver tracking both (or all) signals can create a digital fingerprint to ensure that the signals are genuine and not falsified or otherwise inauthentic before relying on the signals for use in navigation and other geopositioning applications.

The digital fingerprint, such as described herein, is useful for authenticating the signals because each satellite has a unique phase relationship between the signals transmitted from the antennas. The phase relationship is due to the inability to perfectly synchronize the generation of the two (or more) independent signals. This small error is known as differential code bias (DCB). DCB is a function of satellite design and manufacturing tolerances; therefore, it is inherently stable over lengthy periods of time (e.g., several years). Manufacturers construct the satellite so that the DCB is as small as possible. Thus, the ability to intentionally spoof the digital fingerprint requires synchronizing the signals at an order of magnitude better than that of the satellite, which is extraordinarily difficult to achieve from another signal source and therefore unlikely to occur.

### Example GNSS Satellite System

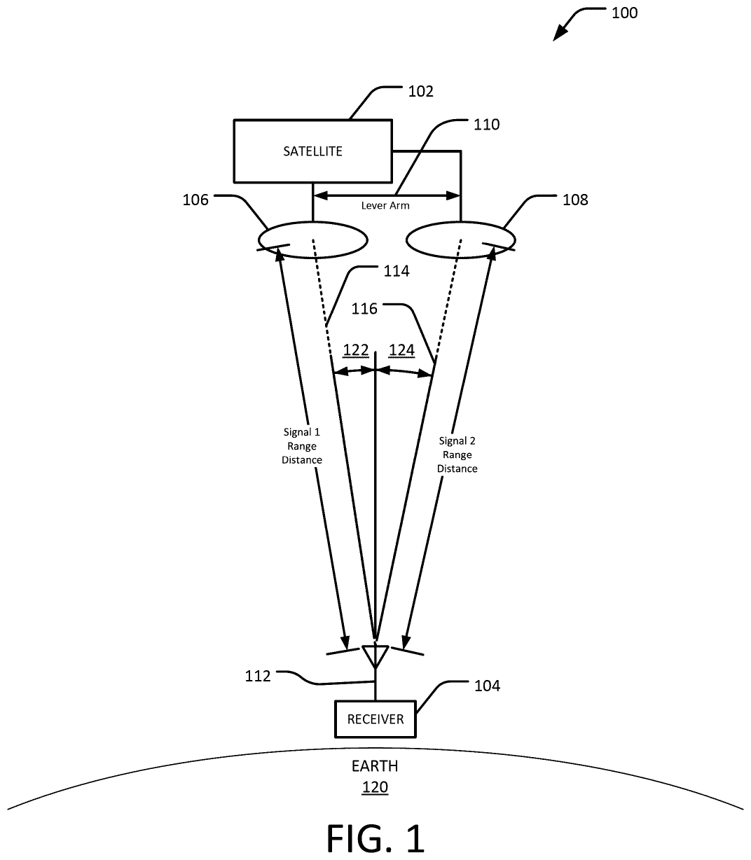

FIG. 1 is a block diagram of a GNSS satellite system 100, in accordance with an example of the present disclosure. FIG. 1 is not drawn to scale, and the dimensions represented in the drawing are provided for clarity. The system 100 includes a satellite platform 102 and a receiver 104. It will be understood that the system 100 can include multiple satellite platforms. The satellite platform 102 has at least two broadcast antennas including a first transmit antenna 106 and a second transmit antenna 108. The first transmit antenna 106 and the second transmit antenna 108 are spatially separated or otherwise physically offset from each other by a distance referred to herein as a lever arm 110. The receiver 104 has a receive antenna 112 for receiving signals broadcast from the first transmit antenna 106 and the second transmit antenna 108.

The satellite platform 102 is in an orbit around the Earth 120, such as a geostationary orbit, a medium earth orbit (MEO), or a low Earth orbit (LEO). The receiver 104 can be located, for example, on land, in air, in space, or at sea. The satellite platform 102 is configured to transmit at least two signals, such as a first GNSS satellite signal 114 and a second GNSS satellite signal 116, from the first and second transmit antenna antennas 106 and 108, respectively. The receiver 104 is configured to receive and process the first GNSS satellite signal 114 and the second GNSS satellite signal 116 for, among other things, determining the geolocation of the receiver 104 and determining that the signals are authentic or falsified.

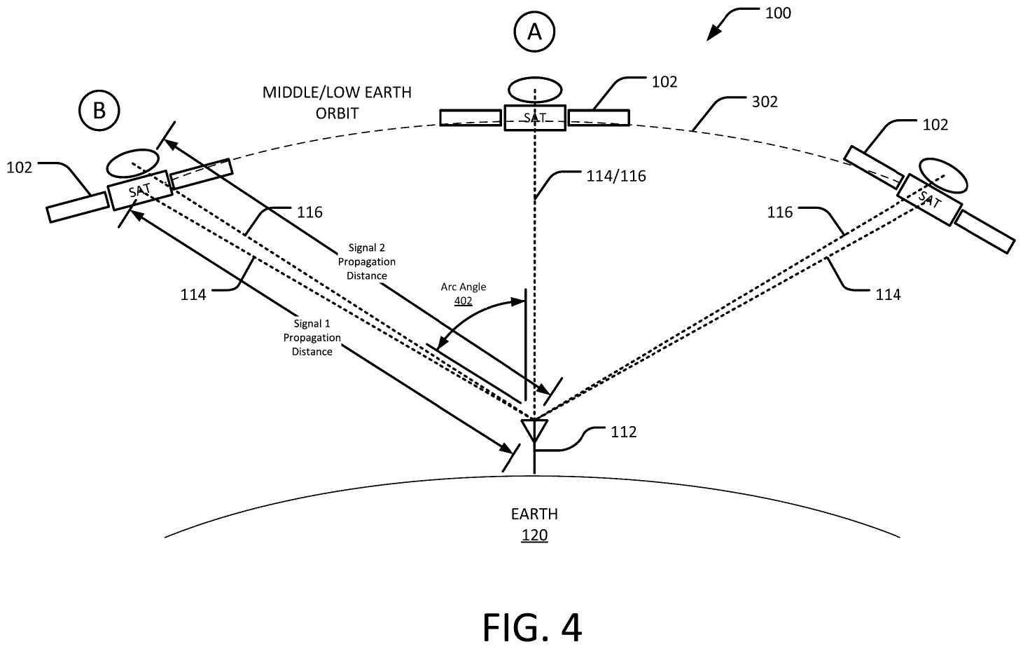

In FIG. 1, the satellite platform 102 with multiple broadcast antennas, including the first transmit antenna 106 and the second transmit antenna 108, is contemporaneously providing the first GNSS satellite signal 114 and the second GNSS satellite signal 116 to the receiver 104. In other words, the first GNSS satellite signal 114 and the second GNSS satellite signal 116 are broadcast at the same time and propagate to the receive antenna 112. Due to the lever arm 110, the receive antenna 112 receives the first GNSS satellite signal 114 at a first angle 122 and the second GNSS satellite signal 116 at a second angle 124. In other words, depending on the orientation of the satellite 102 with respect to the receiver 104, the first GNSS satellite signal 114 and the second GNSS satellite signal 116 arrive at the receive antenna 112 at different angles (e.g., the difference is a sum of the first angle 122 and the second angle 124). Thus, the range (signal propagation) distance of the first GNSS satellite signal 114 from the first transmit antenna 106 to the receive antenna 112 (Signal 1 Range Distance) may be different from the range distance of the second GNSS satellite signal 116 from the second transmit antenna 108 to the receive antenna 112 (Signal 2 Range Distance). The Signal 1 Range Distance of the first GNSS satellite signal 114 can be equal to, greater than, or less than the Signal 2 Range Distance of the second GNSS satellite signal 116, depending on the orientation and position of the first transmit antenna 106 and the second transmit antenna 108 with respect to the receive antenna 112. For instance, the first transmit antenna 106 may be closer to the receive antenna 112 than the second transmit antenna 108, or vice versa, such as shown in FIG. 4. Thus, if the first transmit antenna 106 is closer to the receive antenna 112 than the second transmit antenna 108, then the range distance of the first GNSS satellite signal 114 is less than the range distance of the second GNSS satellite signal 116. The different between the range distance of the first GNSS satellite signal 114 and the range distance of the second GNSS satellite signal 116 is referred to herein as a geometric range difference. The geometric range difference is realized as a code phase offset of the first GNSS satellite signal 114 and the second GNSS satellite signal 116. The code phase offset, also referred to as a code phase bias, represents a difference between a phase of a ranging code encoded in the first GNSS satellite signal 114 and a phase of a ranging code encoded in the second GNSS satellite signal 116. For example, Earth coverage M-code and RMP can be broadcast from physically separate antennas on the vehicle.

The geometric range difference between the first GNSS satellite signal 114 and the second GNSS satellite signal 116 is unique and calculable based on the location of the receiver 104 relative to the location of the first transmit antenna 106 and the second transmit 108 antenna of the satellite platform 102. Furthermore, the rate of change of the geometric range difference is a predictable function of the motion of the receiver 104 and the motion of the satellite platform 102 over time. The receiver 104 is configured to generate a prediction of the expected relationship between a digital fingerprint representing the code phase offset of the first GNSS satellite signal 114 and the second GNSS satellite signal 116 based on ephemeris data of the satellite platform 102 and the current location of the receiver 104, adjusted by the differential code bias of the first GNSS satellite signal 114 and the second GNSS satellite signal 116. The receiver 104 further computes a digital fingerprint representing a measured relationship between the first GNSS satellite signal 114 and the second GNSS satellite signal 116 as received at the receive antenna 112. In particular, the receiver 104 is configured to measure the relative change of the phase and the phase rate of the digital fingerprint of the first GNSS satellite signal 114 and the second GNSS satellite signal 116 and compare the measured relationship against the prediction. If the measured relationship is the same as the expected relationship, then the first GNSS satellite signal 114 and the second GNSS satellite signal 116 are authentic; otherwise, the first GNSS satellite signal 114, the second GNSS satellite signal 116, or both are suspect and potentially falsified.

GNSS receivers have the ability to measure the ranging signal to very fine resolution. Often measurement noise of only a few millimeters is possible for the GPS carrier phase, while tens of centimeters can be achieved in the GPS ranging code phase (pseudo-range) measurement. This level of accuracy is sufficient for the receiver 104 to observe the lever arm 110 of the first transmit antenna 106 and the second transmit antenna 108 as the satellite platform 102 changes orientation with respect to the location of the receiver 104 as the satellite platform 102 adjusts attitude to direct the Earth coverage beam (e.g., the first GNSS satellite signal 114) nadir.

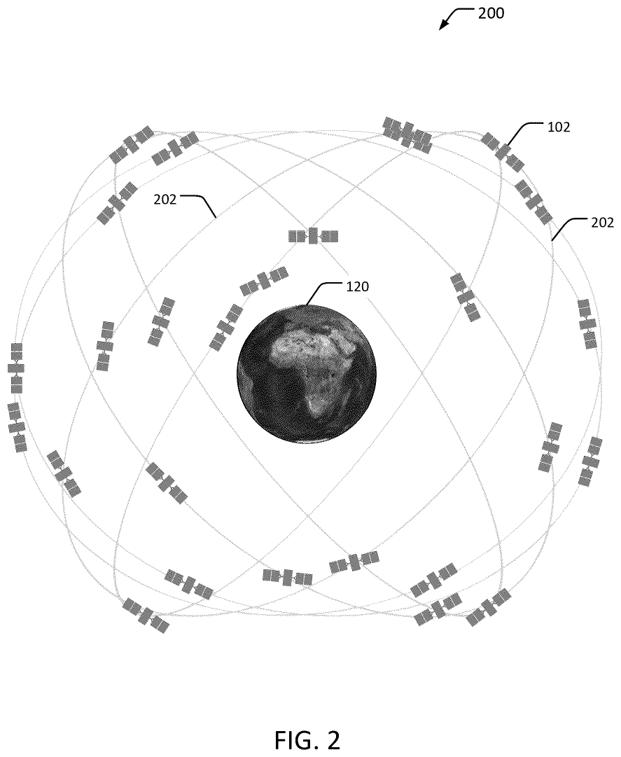

FIG. 2 depicts a constellation 200 of GPS satellites in medium Earth orbit at approximately one-half geosynchronous altitude, which is approximately 22,000 km or 12,550 miles. Each of the satellites follows an orbital path 202 around the Earth 120. Different satellites may follow different orbital paths.

In some examples, an Earth coverage broadcast antenna (e.g., the first transmit antenna 106) creates a planet-shaped gain pattern to achieve uniform signal power distribution at all points visible to the receive antenna 112 from the Earth 120. At least some of the satellite signals, such as the Earth coverage signals transmitted from the first transmit antenna 106, are formed to be broadly visible over as much of the surface of the Earth 120 as possible. The receiver 104 can track such broadly visible signals (e.g., the first GNSS satellite signal 114) anywhere above 5° Earth horizon and maintain lock on the signals until the satellite platform 102 sets below approximately the same elevation. Thus, the ability of the receiver 104 to acquire and track the signals depends on the orbital path 202 of the satellite platform 102. As used herein, the phrase “orbital location” includes a location of a satellite along the orbital path 202 relative to a given point on or above the Earth 120, such as the location of the receiver 104 or another point of reference. Other signals broadcast from the satellite platform 102 may not be as broadly visible from the Earth 120, but in any event are visible over at least a portion of the orbital path 202.

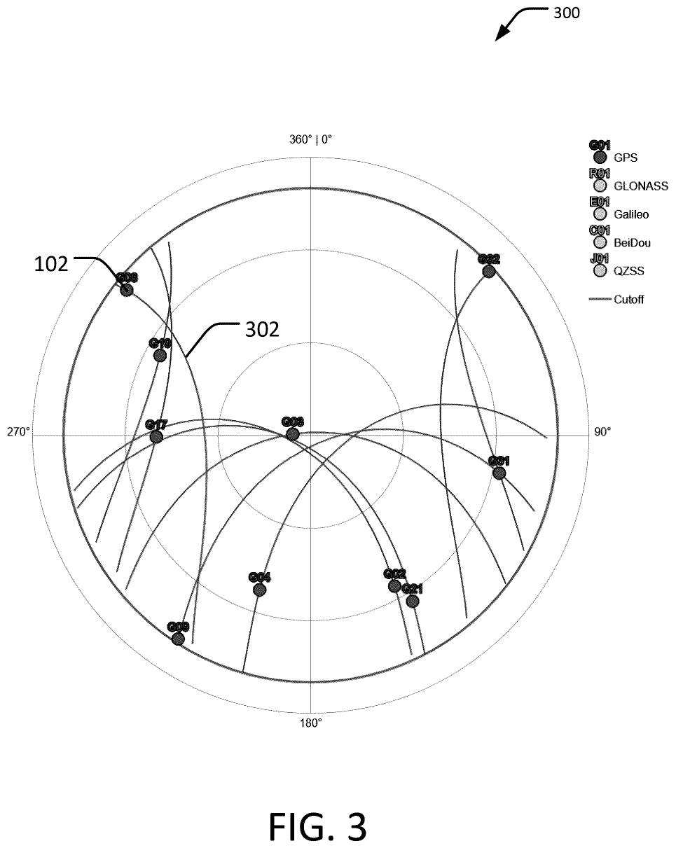

FIG. 3 depicts a view of the sky 300 from the perspective of the receiver 104, in accordance with an example of the present disclosure. A portion of the orbital path 202, such as shown in FIG. 2, is visible by the receiver 104 as an arc 302 scribed across the sky as the satellite platform 102 orbits the Earth 120, such as shown in FIG. 3. The orbital location of the satellite platform 102 relative to the location of the receiver 104 for non-geostationary orbits is a function of the arc 302 of the satellite platform 102. If the satellite platform 102 is in geostationary orbit and visible by the receiver 104, then the orbital location of the satellite platform 102 relative to the location of the receiver 104 is a constant point in the sky. The arc 302 changes as the location of the receiver 104, as thus the view of the sky 300, changes. However, the disclosed techniques are applicable whether the location of the receiver 104 changes or remains stationary because the orbital location of the satellite platform 102 can be measured and predicted from any location.

Satellites in the constellation 200 provide a diversity of satellite orientations from the perspective of the receive antenna 112. As the orbital location and orientation of each satellite platform 102 changes relative to the receiver 104, the receiver 104 computes a unique digital signature from a measurement of the relative code phase between the first GNSS satellite signal 114 and the second GNSS satellite signal 116. The receiver 104 compares the digital signature against known or predicted values of the relative code phase for authenticating the first GNSS satellite signal 114 and the second GNSS satellite signal 116.

FIG. 4 is a block diagram of the GNSS satellite system 100 of FIG. 1 showing the satellite platform 102 at different orbital locations with respect to the receive antenna 112, in accordance with an example of the present disclosure. FIG. 4 shows a two-dimensional representation showing how the lever arm 110 (such as shown in FIG. 1) affects the range difference between the first GNSS satellite signal 114 and the second GNSS satellite signal 116 as a function of satellite orientation during orbit. When the satellite platform 102 is directly above the receive antenna 112, as indicated at position “A” in FIG. 4 and also shown in FIG. 1, the geometric distance between the first transmit antenna 106 and the second transmit antenna 108 represents the lever arm 110. As the satellite orbits away from the overhead location, as indicated at position “B” in FIG. 4, the range difference is scaled by the cosine of an arc angle 402 between the location of the receive antenna 112 and the point nadir of the satellite platform 102 relative to the location of the receive antenna 112.

As noted above, a differential code bias (DCB) is present in the satellite that is unique to each individual space vehicle at time of build and deployment. While the manufacturer attempts to minimize this error, making it as close to perfectly aligned as possible, small errors accumulate in the electronic generation of the two ranging codes, differences in cabling and antenna group delay, and other minute effects that are a function of the individual satellite. The receiver 104 measures this small differential error in the first GNSS satellite signal 114 and the second GNSS satellite signal 116 and compares it against the DCB and the lever arm 110 to provide a satellite-unique digital fingerprint representing the range difference in the first GNSS satellite signal 114 and the second GNSS satellite signal 116. The error is the accumulated contributions from dozens of miniscule sources too small to predict or model, and therefore is measured on the completed spacecraft following manufacturing. The bias changes slowly over time and is continuously monitored and calibrated by ground observation equipment, with anticipated updates occurring about once per year. The random composition of the code bias error, combined with the relative stability and slow variation over time significantly increase the difficulty of spoofing due to the fine control that is required.

### Example Receiver Device

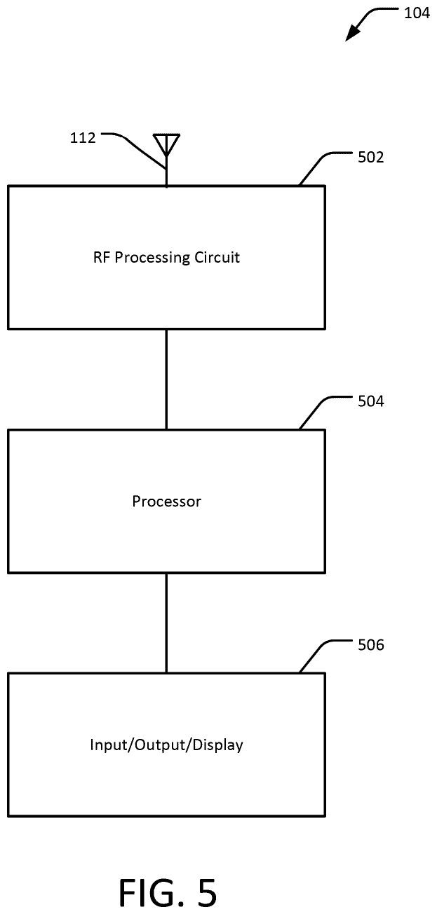

FIG. 5 is a block diagram of the receiver 104 of the GNSS satellite system 100 of FIG. 1, in accordance with an example of the present disclosure. As discussed above, the receiver 104 is configured to receive signals broadcast from the satellite platform 102, including the first GNSS satellite signal 114 and the second GNSS satellite signal 116 via the receive antenna 112. The receiver 104 includes a radio frequency (RF) processing circuit 502, a processor 504, and an input/output/display unit 506. The RF processing circuit 502 is configured to provide a digital representation of the first GNSS satellite signal 114 and the second GNSS satellite signal 116 from the receive antenna 112 to the processor 504, which generates a digital fingerprint from the digital representation of the signals. For example, the RF processing circuit 502 can include an RF downconverter, an analog-to-digital signal converter, and/or a digital signal processor. The RF processing circuit 502 thus converts the RF signals (e.g., the first GNSS satellite signal 114 and the second GNSS satellite signal 116) from analog to digital (e.g., a first digital signal and a second digital signal) for further processing by the processor 504. As noted above, the first GNSS satellite signal 114 and the second GNSS satellite signal 116 each include a ranging code that uniquely identifies a GNSS satellite (e.g., the satellite platform 102) contemporaneously transmitting the first GNSS satellite signal 114 and the second GNSS satellite signal 116 from physically separate antennas (e.g., the first transmit antenna 106 and the second transmit antenna 108) onboard the GNSS satellite. It will be understood that the RF processing circuit 502 can be further configured to process additional signals received via the receive antenna 112 from one or more GNSS satellites.

The processor 504 is configured to compute a digital fingerprint based on the first digital signal and the second digital signal, and determine that the first GNSS satellite signal and the second GNSS satellite signal are authentic based on the digital fingerprint. The digital fingerprint is a function of a measured relationship between the first digital signal and the second digital signal.

As noted above, the first GNSS satellite signal 114 and the second GNSS satellite signal 116 are broadcast from physically separate antennas (e.g., the first transmit antenna 106 and the second transmit antenna 108), which are separated by the lever arm 110 distance. The lever arm 110 thus causes the first GNSS satellite signal 114 and the second GNSS satellite signal 116, which are broadcast contemporaneously, to arrive at the receive antenna 112 at different times causing a phase difference between the signals. The phase difference is unique to the satellite platform 102 and can thus be used to verify the authenticity of the first GNSS satellite signal 114 and the second GNSS satellite signal 116. Furthermore, as the satellite platform 102 proceeds along its orbit, the rate of change of the phase difference between the first GNSS satellite signal 114 and the second GNSS satellite signal 116 is also unique to the satellite platform 102.

The processor 504 is configured to measure the relative change of the digital representations of the phase and the phase rate of the first GNSS satellite signal 114 and second GNSS satellite signal 116. In some examples, the function of the measured relationship between the first digital signal and the second digital signal includes a differential code bias that is unique to the satellite platform 102. In some examples, the first GNSS satellite signal 114 is an Earth coverage M-code signal and the second GNSS satellite signal 116 is an RMP signal. Thus, the measured relationship represents a digital representation of the range difference between the first GNSS satellite signal 114 and the second GNSS satellite signal 116, where the range difference is scaled by a cosine of an arc angle between the location of the receive antenna 112 and a point nadir of the satellite platform 102 with respect to the location of the receive antenna 112.

Since the predicted, or expected, digital signature representing the range difference for the satellite platform 102 is known a priori based on satellite ephemeris and the location of the receive antenna 112 relative to the orbital location of the satellite platform 102, the measured range difference can be compared to the predicted range difference for the satellite. For instance, the correlation codes for the satellite platform 102 are known a priori by the receiver and are used to de-spread the signal to get back to a data-modulated carrier signal. The satellite transmit is 30 dB below the noise floor and the receiver uses the known de-spreading code to acquire the signal. The processor 504 is further configured to determine that the digital fingerprint is authentic if the measured relationship is the same as an expected relationship between the first GNSS satellite signal 114 and the second GNSS satellite signal 116 for an orbital location of the satellite platform 102 with respect to a location of the receive antenna 112. Likewise, the processor 504 can be further configured to determine that the digital fingerprint is potentially falsified if the measured relationship is different from the expected relationship between the first GNSS satellite signal 114 and the second GNSS satellite signal 116.

In some examples, the processor 504 is configured to initiate one or more remedial actions, such as causing an indication on the display 506, or providing another indication, that the first GNSS satellite signal 114 and the second GNSS satellite signal 116 are authentic or potentially falsified. The indication of authenticity can include, for example, text such as “satellite verified,” “signal verified,” “OK,” or a graphical symbol such as a check mark. The indication of falsification can include, for example, text such as “satellite invalid,” “signal invalid,” “unverified,” or a graphical symbol such as a cross. Such an indication is useful for a user to determine whether the signals are genuine or spoofed and therefore untrustworthy, and to take further appropriate action.

In some examples, the processor 504 can be configured to suppress navigation and timing information from the output or display 506 while the first GNSS satellite signal 114 and/or the second GNSS satellite signal 116 are determined to be potentially falsified or otherwise unverified so as to prevent the user from accessing and using untrusted data. In some examples, the processor 504 can be further configured to receive a user input via the input 506 to override the suppression, such as for diagnostic, investigative, or intelligence gathering purposes (e.g., to determine the source or nature of the potentially falsified signal or to troubleshoot or test the receiver 104).

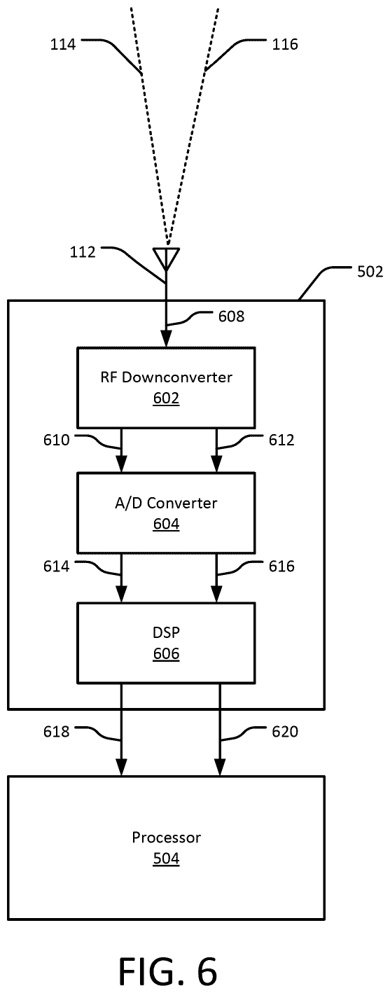

FIG. 6 is a block diagram of a portion of the receiver 104 of the GNSS satellite system 100 of FIG. 1, in accordance with an example of the present disclosure. As noted above, the RF processing circuit 502 is configured to provide a digital representation of the first GNSS satellite signal 114 and the second GNSS satellite signal 116 from the receive antenna 112 to the processor 504. The RF processing circuit 502 includes an RF downconverter 602, an analog-to-digital (A/D) converter 604, and a digital signal processor (DSP) 606.

The RF downconverter 602 down-converts the first GNSS satellite signal 114 and the second GNSS satellite signal 116, received via the antenna 112 as signal 608, to intermediate frequency signals 610 and 612, respectively, which are suitable for further processing by the A/D converter 604. The A/D converter 604 converts the intermediate frequency signals 610 and 612 into intermediate digital signals 614 and 616, which are digital representations of the first GNSS satellite signal 114 and the second GNSS satellite signal 116, respectively. Depending on a frequency plan used for subsequent processing of the intermediate digital signals 614 and 616, the DSP 606 pre-processes the intermediate digital signals 614 and 616 by converting the signals to baseband (I & Q) signals and/or downsampling the intermediate digital signals 614 and 616 to reduce the sample rate (from the A/D converter 604) to the desired rate for further processing by the processor 504. The DSP 606 outputs pre-processed digital signals 618 and 620 representing the first GNSS satellite signal 114 and the second GNSS satellite signal 116, respectively.

### FURTHER EXAMPLE EMBODIMENTS

The following examples pertain to further embodiments, from which numerous permutations and configurations will be apparent.

Example 1 provides a global navigation satellite system (GNSS) signal authentication system comprising a receive antenna configured to receive GNSS satellite signals including a first GNSS satellite signal and a second GNSS satellite signal from a single satellite; and a processor configured to compute a digital fingerprint based on a first digital signal and a second digital signal representing the first GNSS satellite signal and the second GNSS satellite signal, respectively, and determine that the first GNSS satellite signal and the second GNSS satellite signal are authentic based on the digital fingerprint, wherein the first digital signal and the second digital signal each include a ranging code that uniquely identifies a GNSS satellite that contemporaneously transmitted the first GNSS satellite signal and the second GNSS satellite signal from physically separate antennas of the GNSS satellite.

Example 2 includes the subject matter of Example 1, wherein the digital fingerprint is a function of a measured relationship between a code phase of the first GNSS satellite signal and a code phase of the second GNSS satellite signal.

Example 3 includes the subject matter of Example 2, wherein the digital fingerprint is determined to be authentic if the measured relationship is the same as an expected relationship between the first GNSS satellite signal and the second GNSS satellite signal for an orbital location of the GNSS satellite with respect to a location of the receive antenna.

Example 4 includes the subject matter of Example 3, wherein the expected relationship between the first GNSS satellite signal and the second GNSS satellite signal is based on satellite ephemeris and the location of the receive antenna relative to the orbital location of the GNSS satellite.

Example 5 includes the subject matter of any one of Examples 3 and 4, wherein the measured relationship and the expected relationship each represent a range difference between the first GNSS satellite signal and the second GNSS satellite signal, the range difference being scaled by a cosine of an arc angle between the location of the receive antenna and a point nadir of the GNSS satellite with respect to the location of the receive antenna.

Example 6 includes the subject matter of any one of Examples 3-5, wherein the function of the measured relationship between the first GNSS satellite signal and the second GNSS satellite signal includes a differential code bias that is unique to the GNSS satellite.

Example 7 includes the subject matter of any one of Examples 1-6, wherein the first GNSS satellite signal is an Earth coverage M-code signal, and the second GNSS satellite signal is an RMP signal.

Example 8 includes the subject matter of any one of Examples 1-7, further comprising a radio frequency (RF) receiver circuit coupled between the receive antenna and the processor, the RF receiver circuit configured to convert the first GNSS satellite signal and the second GNSS satellite signal into the first digital signal and the second digital signal, respectively.

Example 9 provides a global navigation satellite system (GNSS) signal authentication method comprising receiving, by one or more processors, a first digital signal and a second digital signal, the first digital signal and the second digital signal each representing a first GNSS satellite signal and a second GNSS satellite signal, respectively, received from a GNSS satellite and including a ranging code that uniquely identifies the GNSS satellite, the first and second GNSS satellite signals transmitted contemporaneously from physically separate antennas onboard the GNSS satellite; computing, by the one or more processors, a digital fingerprint based on the first digital signal and the second digital signal; and determining, by the one or more processors, that the first GNSS satellite signal and the second GNSS satellite signal are authentic based on the digital fingerprint.

Example 10 includes the subject matter of Example 9, wherein the digital fingerprint is a function of a first measured relationship between the first digital signal and the second digital signal, the first measured relationship being representative of a second measured relationship between a code phase of the first GNSS satellite signal and a code phase of the second GNSS satellite signal.

Example 11 includes the subject matter of Example 10, wherein the digital fingerprint is determined to be authentic if the measured relationship is the same as an expected relationship between the first digital signal and the second digital signal for an orbital location of the GNSS satellite with respect to a location of the receive antenna.

Example 12 includes the subject matter of Example 11, wherein the expected relationship between the first digital signal and the second digital signal is based on satellite ephemeris and the location of the receive antenna relative to the orbital location of the GNSS satellite.

Example 13 includes the subject matter of any one of Examples 11 and 12, wherein the measured relationship and the expected relationship each represent a range difference between the first digital signal and the second digital signal, the range difference being scaled by a cosine of an arc angle between the location of the receive antenna and a point nadir of the GNSS satellite with respect to the location of the receive antenna.

Example 14 includes the subject matter of any one of Examples 11-13, wherein the function of the measured relationship between the first digital signal and the second digital signal includes a differential code bias that is unique to the GNSS satellite.

Example 15 includes the subject matter of any one of Examples 9-14, wherein the first GNSS satellite signal is an Earth coverage M-code signal and the second GNSS satellite signal is an RMP signal.

Example 16 includes the subject matter of any one of Examples 9-15, further comprising determining, by the one or more processors, that the first digital signal and the second digital signal are not authentic based on the digital fingerprint; and initiating one or more remedial actions.

Example 17 provides a system comprising a global navigation satellite system (GNSS) receive antenna; a processor; a display operative coupled to the processor, and a circuit configured to generate a first digital signal and a second digital signal from the receive antenna to the processor, the first digital signal and the second digital signal each representing a first GNSS satellite signal and a second GNSS satellite signal, respectively, received from a GNSS satellite and including a ranging code that uniquely identifies the GNSS satellite, the first GNSS satellite signal and the second GNSS satellite signal contemporaneously transmitted from physically separate antennas onboard the GNSS satellite, wherein the processor is configured to determine that the first GNSS satellite signal and the second GNSS satellite signal are authentic or not authentic based on the first digital signal and the second digital signal, and cause the display to provide an indication that the first GNSS satellite signal and the second GNSS satellite signal are authentic or not authentic.

Example 18 includes the subject matter of Example 17, wherein the processor is further configured to compute a digital fingerprint as a function of a measured relationship between a code phase of the first digital signal and a code phase of the second digital signal, and the first digital signal and the second digital signal are determined to be authentic if the digital fingerprint is the same as an expected relationship between the first digital signal and the second digital signal for an orbital location of the GNSS satellite with respect to a location of the receive antenna.

Example 19 includes the subject matter of Example 18, wherein the expected relationship between the first digital signal and the second digital signal is based on satellite ephemeris and the location of the receive antenna relative to the orbital location of the GNSS satellite.

Example 20 includes the subject matter of Example 19, wherein the digital fingerprint and the expected relationship each represent a range difference between the first digital signal and the second digital signal, the range difference being scaled by a cosine of an arc angle between the location of the receive antenna and a point nadir of the GNSS satellite with respect to the location of the receive antenna, and wherein the function of the measured relationship between the first digital signal and the second digital signal includes a differential code bias that is unique to the GNSS satellite.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A global navigation satellite system (GNSS) signal authentication system comprising:
a receive antenna configured to receive GNSS satellite signals including a first GNSS satellite signal and a second GNSS satellite signal from a single satellite; and
a processor configured to compute a digital fingerprint based on a first digital signal and a second digital signal representing the first GNSS satellite signal and the second GNSS satellite signal, respectively, and determine that the first GNSS satellite signal and the second GNSS satellite signal are authentic based on the digital fingerprint, wherein the first digital signal and the second digital signal each include a ranging code that uniquely identifies a GNSS satellite that contemporaneously transmitted the first GNSS satellite signal and the second GNSS satellite signal from physically separate antennas of the GNSS satellite.

2. The system of claim 1, wherein the digital fingerprint is a function of a measured relationship between a code phase of the first GNSS satellite signal and a code phase of the second GNSS satellite signal.

3. The system of claim 2, wherein the digital fingerprint is determined to be authentic if the measured relationship is the same as an expected relationship between the first GNSS satellite signal and the second GNSS satellite signal for an orbital location of the GNSS satellite with respect to a location of the receive antenna.

4. The system of claim 3, wherein the expected relationship between the first GNSS satellite signal and the second GNSS satellite signal is based on satellite ephemeris and the location of the receive antenna relative to the orbital location of the GNSS satellite.

5. The system of claim 3, wherein the measured relationship and the expected relationship each represent a range difference between the first GNSS satellite signal and the second GNSS satellite signal, the range difference being scaled by a cosine of an arc angle between the location of the receive antenna and a point nadir of the GNSS satellite with respect to the location of the receive antenna.

6. The system of claim 3, wherein the function of the measured relationship between the first GNSS satellite signal and the second GNSS satellite signal includes a differential code bias that is unique to the GNSS satellite.

7. The system of claim 1, wherein the first GNSS satellite signal is an Earth coverage M-code signal, and the second GNSS satellite signal is an RMP signal.

8. The system of claim 1, further comprising a radio frequency (RF) receiver circuit coupled between the receive antenna and the processor, the RF receiver circuit configured to convert the first GNSS satellite signal and the second GNSS satellite signal into the first digital signal and the second digital signal, respectively.

9. A global navigation satellite system (GNSS) signal authentication method comprising:
receiving, by one or more processors, a first digital signal and a second digital signal, the first digital signal and the second digital signal each representing a first GNSS satellite signal and a second GNSS satellite signal, respectively, received from a GNSS satellite and including a ranging code that uniquely identifies the GNSS satellite, the first GNSS satellite signal and the second GNSS satellite signal transmitted contemporaneously from physically separate antennas onboard the GNSS satellite;
computing, by the one or more processors, a digital fingerprint based on the first digital signal and the second digital signal; and
determining, by the one or more processors, that the first GNSS satellite signal and the second GNSS satellite signal are authentic based on the digital fingerprint.

10. The method of claim 9, wherein the digital fingerprint is a function of a first measured relationship between the first digital signal and the second digital signal, the first measured relationship being representative of a second measured relationship between a code phase of the first GNSS satellite signal and a code phase of the second GNSS satellite signal.

11. The method of claim 10, wherein the digital fingerprint is determined to be authentic if the measured relationship is the same as an expected relationship between the first digital signal and the second digital signal for an orbital location of the GNSS satellite with respect to a location of a receive antenna.

12. The method of claim 11, wherein the expected relationship between the first digital signal and the second digital signal is based on satellite ephemeris and the location of the receive antenna relative to the orbital location of the GNSS satellite.

13. The method of claim 11, wherein the measured relationship and the expected relationship each represent a range difference between the first digital signal and the second digital signal, the range difference being scaled by a cosine of an arc angle between the location of the receive antenna and a point nadir of the GNSS satellite with respect to the location of the receive antenna.

14. The method of claim 11, wherein the function of the measured relationship between the first digital signal and the second digital signal includes a differential code bias that is unique to the GNSS satellite.

15. The method of claim 9, wherein the first GNSS satellite signal is an Earth coverage M-code signal and the second GNSS satellite signal is an RMP signal.

16. The method of claim 9, further comprising:
determining, by the one or more processors, that the first digital signal and the second digital signal are not authentic based on the digital fingerprint; and
initiating one or more remedial actions.

17. A system comprising:
a global navigation satellite system (GNSS) receive antenna;
a processor;
a display operative coupled to the processor, and
a circuit configured to generate a first digital signal and a second digital signal from the receive antenna to the processor, the first digital signal and the second digital signal each representing a first GNSS satellite signal and a second GNSS satellite signal, respectively, received from a GNSS satellite and including a ranging code that uniquely identifies the GNSS satellite, the first GNSS satellite signal and the second GNSS satellite signal contemporaneously transmitted from physically separate antennas onboard the GNSS satellite,
wherein the processor is configured to
determine that the first GNSS satellite signal and the second GNSS satellite signal are authentic or not authentic based on the first digital signal and the second digital signal, and
cause the display to provide an indication that the first GNSS satellite signal and the second GNSS satellite signal are authentic or not authentic.

18. The system of claim 17, wherein the processor is further configured to compute a digital fingerprint as a function of a measured relationship between a code phase of the first digital signal and a code phase of the second digital signal, and the first digital signal and the second digital signal are determined to be authentic if the digital fingerprint is the same as an expected relationship between the first digital signal and the second digital signal for an orbital location of the GNSS satellite with respect to a location of the receive antenna.

19. The system of claim 18, wherein the expected relationship between the first digital signal and the second digital signal is based on satellite ephemeris and the location of the receive antenna relative to the orbital location of the GNSS satellite.

20. The system of claim 19, wherein the digital fingerprint and the expected relationship each represent a range difference between the first digital signal and the second digital signal, the range difference being scaled by a cosine of an arc angle between the location of the receive antenna and a point nadir of the GNSS satellite with respect to the location of the receive antenna, and wherein the function of the measured relationship between the first digital signal and the second digital signal includes a differential code bias that is unique to the GNSS satellite.
